(19) United States
(12) Patent Application Publication
(10) Pub. No.: US 2013/0126095 A1
(43) Pub. Date: May 23, 2013

(54) APPARATUS FOR COMPOSITE TAPE DISPENSING

(71) Applicant: Zoltek Companies, Inc., St. Louis, MO (US)

(72) Inventors: Rolf M. JOHNS, Brigham City, UT (US); Daniel K. BUCKMILLER, Herriman, UT (US)

(73) Assignee: ZOLTEK COMPANIES, INC., St. Louis, MO (US)

(21) Appl. No.: 13/744,651

(22) Filed: Jan. 18, 2013

Related U.S. Application Data
(63) Continuation-in-part of application No. PCT/US2011/048051, filed on Aug. 17, 2011.
Application No. PCT/US2011/048051 is a continuation of application No. PCT/US2012/049696, filed on Aug. 6, 2012.
(60) Provisional application No. 61/374,580, filed on Aug. 17, 2010.
(60) Provisional application No. 61/430,427, filed on Jan. 6, 2011.

(51) Int. Cl. B32B 38/18

(52) U.S. Cl. CPC B32B 38/1808
USPC 156/361

(57) ABSTRACT

An apparatus to apply a resin impregnated tape to the surface of a molding tool, the apparatus including: an upper frame mounted to a base frame, the upper frame having mounted thereon a spool holding assembly for holding a spool of resin impregnated tape wound thereon, a tape compaction assembly including a compaction roller configured to conform to the surface of the molding tool for compacting the resin impregnated tape onto the surface of the molding tool, and a tape tensioning system for exerting tension on the resin impregnated tape. The base frame includes a tracking system for tracking the surface of the molding tool, the base frame being reciprocally movable with respect to the surface of the molding tool.

### TECHNICAL FIELD

The present invention relates to an apparatus for dispensing composite tape, and more particularly, to an apparatus for laying down prepreg tapes with precision. The apparatus can lay down prepreg onto a molding structure having a contoured surface or a flat surface along a linear or non-linear path.

### BACKGROUND

In composite technology, a resin preimpregnated web or tape may be used to construct the particular component desired. Prepreg materials consist of aligned reinforcing fibers (typically carbon, glass, or aramid fibers) that are pre-impregnated with a polymer and used as an intermediate product in the molding of composite structures. Very often these fibers are collimated in a unidirectional configuration forming tape-like products that are typically 12 to 60 inches (30.5 to 152.4 cm) wide.

The composite structure is built up of successive layers of the tape applied to a working surface such as, for example, a molding tool, mandrel, or any surface used to form composite parts. When building up a composite wind blade, wind blade spar, or wing structures, for example, from prepreg tapes, long lengths (i.e., greater than 40 meters) of prepreg tape are laid down on a molding tool with great precision. Precise filament alignment is required to achieve the desired composite properties. In addition, uniform compaction of the prepreg tape during the laminate build-up is required to minimize entrapped air, which can cause voids in the cured composite laminate. Very slight misalignment of fiber orientation can cause significant loss of critical engineering properties. For example, 5 to 10 degrees off orientation can cause a 10 to 20% loss in composite modulus of elasticity. Voids in the composite can also result in lower composite properties. Greater than 2% voids can cause significant loss of inter-laminar shear strength and can act as sites for damage growth in the composite during service life.

Composite wind blade spars are often straight-sided laminates of varying thickness, for example, from approximately 0.1 inch (0.25 cm) to over 1.5 inches (3.81 cm) thick. They are typically laid up mold surfaces that can range from flat to varying degrees of concave or convex curvature. For example, the wind blade spar may be flat at the tip and curved at the root. This configuration further adds to the complexity of laying down prepreg tapes with extreme precision. Hand layup of these spars with prepreg tapes is extremely difficult and time consuming, and assuring precision is even more difficult. The alternate extreme to hand layup involves the use of automated tape laying machines. These types of machines have been developed for over two decades, primarily for aerospace structures. While these machines are designed to lay down prepreg tapes with extreme precision, these machines are very expensive and overly complex for wind blade spars.

### SUMMARY

The present invention is directed to an apparatus that is capable of laying down a wide prepreg product for a structure having in-plane curvature, while significantly reducing the effects of wrinkling on the inner radius.

In one aspect of the invention, there is provided an apparatus to apply a resin impregnated tape to the surface of a molding tool, the apparatus including: an upper frame mounted to a base frame, the upper frame having mounted thereon a spool holding assembly for holding a spool of resin impregnated tape wound thereon, a tape compaction assembly including a compaction roller configured to conform to the surface of the molding tool for compacting the resin impregnated tape onto the surface of the molding tool, and a tape tensioning system for exerting tension on the resin impregnated tape. The base frame includes a tracking system for tracking the surface of the molding tool, the base frame being reciprocally movable with respect to the surface of the molding tool.

In one embodiment, the spool holding assembly includes an alignment system for laterally aligning the spool of prepreg tape relative to the surface of the molding tool.

In one embodiment, the compaction roller includes a plurality of contiguous disks supported on an axle, the disks having a central bore diameter that is greater than the outer diameter of the axle.

In one embodiment, the upper frame is rotatably mounted on the base frame. The upper frame may rotate at least 180° on the base frame to permit changing the direction of application of the resin impregnated tape on the surface of the molding tool. The apparatus may further include a turntable coupled to the upper frame and the base frame to permit rotation of the upper frame on the base frame.

In one embodiment, the tape tensioning system includes an actuated disk brake. The disk brake may be manually or automatically actuated.

In one embodiment, the molding tool includes at least one rail and the tracking system includes at least two guide rollers that engage the at least one rail.

The surface of the molding tool may include at least one of a convex contour and a concave contour.

The width of the resin impregnated tape applied to the molding tool, in one embodiment, is within the range of about 11.5 inches (292 mm) to about 60 inches (152.4 cm).

In a further aspect of the invention, that apparatus further includes a slitter for slitting the resin impregnated tape lengthwise into a plurality of strips, the slitter mounted on and rotatable with the upper frame. The slitter may include a plurality of stationary or rotary knives.

In one embodiment, the plurality of strips of resin impregnated tape is uniform. In another embodiment, the width of the plurality of strips of resin impregnated tape is non-uniform.

In one embodiment, the apparatus further includes a plurality of accumulator rollers disposed downstream of the slitter, each accumulator roller being independently activatable for accumulating and de-accumulating a portion of a respective strip of resin impregnated tape, the accumulator rollers mounted on and rotatable with the upper frame.

In one embodiment, the apparatus further comprising a controller configured to control at least one of: the placement of the resin impregnated tape on the surface of the molding tool; the tension exerted by the tensioning system on the tape; the direction in which the tape is applied to the surface of the molding tool; and the speed at which the tape is applied to the surface of the molding tool.

In one aspect of the invention there is provided a carriage to apply a resin impregnated web to the contoured surface of molding tool, the carriage including: an upper frame mounted to a base frame, the upper frame having mounted thereon: a first spool holding assembly for holding a spool of resin impregnated web wound thereon, a second spool holding assembly for holding a spool of scrim material mounted thereon; a web compaction assembly including a compaction roller configured to conform to concave and convex portions of the surface of the molding tool for compacting the resin impregnated web onto the surface of the molding tool, and a web tensioning system for exerting tension on the resin impregnated web. The base frame includes: a plurality of wheels mounted on the base frame and supporting the carriage, the wheels engaging the surface of the molding tool for propelling the carriage along the contoured surface of the wind blade spar cap molding tool; and a tracking system for tracking the surface of the molding tool, the carriage reciprocally movable with respect to the contours of the surface of the molding tool.

In one embodiment, the carriage further includes a nip for joining a layer of scrim material from the spool of scrim material to the resin impregnated web prior to compacting the resin impregnated web onto the surface of the molding tool.

### BRIEF DESCRIPTION OF THE DRAWINGS

In the annexed drawings, like references indicate like parts or features:

FIG. 1 is a perspective view of an apparatus for laying down prepreg tape according to an embodiment of the invention.

FIG. 2 is a top view of the apparatus of FIG. 1.

FIG. 3 is a front view of the apparatus of FIG. 1 with a spool of prepreg material mounted thereon.

FIG. 4 is a side view of the apparatus of FIG. 1 with a spool of prepreg material mounted thereon.

FIG. 5 is a perspective view of an embodiment of the apparatus for laying down prepreg tape according to the invention as positioned on a molding tool.

FIG. 6 is a front view of the apparatus of FIG. 5.

FIG. 7 is a perspective view of the apparatus of FIG. 5, illustrating rotational motion of the upper frame.

FIG. 8 is a perspective view of an apparatus for laying down prepreg tape that includes tape slitting and dispensing assemblies in accordance with an embodiment of the present invention.

FIG. 9 is a side view of the apparatus of FIG. 8.

FIG. 10 is a top view of the apparatus of FIG. 8.

FIG. 11 is an enlarged top view of the tensioning system of the apparatus of FIG. 8.

FIG. 12 is a side view of a section of the apparatus of FIG. 8 with a spool of prepreg material mounted thereon.

FIG. 13 is a perspective view of the tape alignment assembly of the apparatus of FIG. 8.

FIG. 14 is a bottom view of the tape positioning assembly of the apparatus of FIG. 8.

FIG. 15A is a schematic drawing illustrating a prepreg tape dispensed using conventional apparatus in a linear direction.

FIG. 15B is a schematic drawing illustrating a prepreg tape dispensed using conventional apparatus in a non-linear direction.

FIG. 16 is a photograph showing a prepreg tape dispensed using conventional apparatus onto a curved surface.

FIG. 17 is a perspective view of an embodiment of the apparatus including a scrim dispensing assembly according to the invention

### DETAILED DESCRIPTION

The apparatus of the present invention is useful for forming composite laminated structures by applying tape of continuous fibers that have been preimpregnated with a resin binder onto a surface of a mold, mandrel or tool. The fibers may consist of carbon, glass, ceramic, metal, and/or polymers. The resin binder may be a thermoset or thermoplastic resin.

In one aspect of the invention, an apparatus for laying down a wide, unidirectional prepreg tape for a structure, and in particular, for a wind blade, is provided. The apparatus includes a spool holder for demountably holding a spool of a continuous web of prepreg material having a wide width. The apparatus includes a mechanism for properly placing the prepreg on the surface of the molding tool. In addition, the apparatus includes a rotatably mounted prepreg tape placement assembly for bi-directional tape placement and compaction.

The width of the prepreg tape product is typically in the range of about 11.5 inches (292 mm) to about 60 inches (152.4 cm). In one embodiment, the width of the prepreg tape is about 12 inches (30.5 cm) to about 60 inches (152.4 cm), or about 11.5 inches (292 mm) to about 15.75 inches (400 mm). In general, it is advantageous to use wider prepreg tape so as to increase the rate of prepreg tape lay down, and thus increase production efficiency. With the apparatus of the present invention, it is possible to further increase production rates by providing bi-directional tape placement and compaction. Application of the prepreg material on the molding tool may be carried out in the forward direction and in the reverse direction.

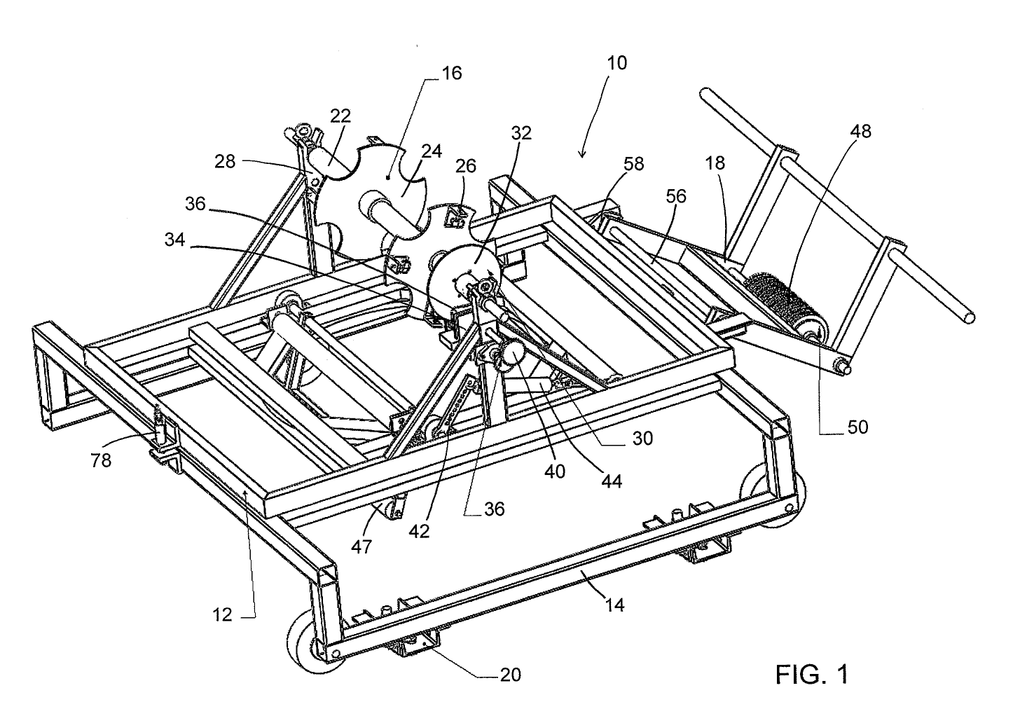

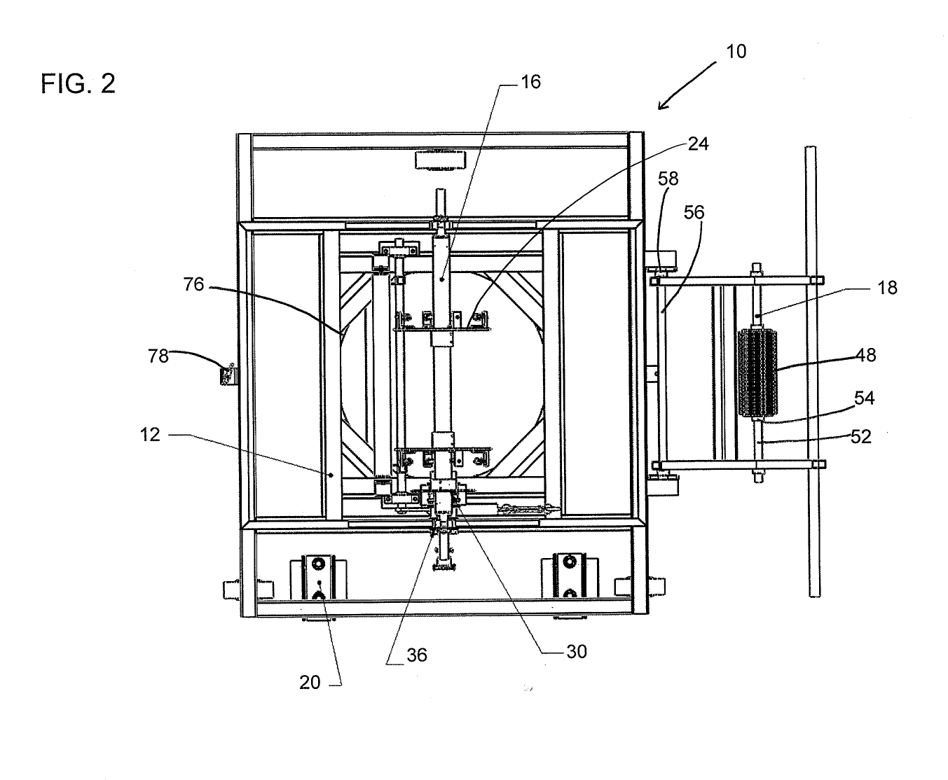

Referring to FIGS. 1-3, in one embodiment of the invention, the prepreg tape laying apparatus is a carriage 10 that includes an upper frame 12 rotatably mounted to a base frame 14. Mounted on the upper frame 12 are a prepreg spool holding assembly 16 and a compaction assembly 18. The base frame 14 includes a tracking system 20 to precisely place the prepreg material on the surface of the molding tool.

The spool holding assembly 16 includes a spindle 22 and spool supports 24 mounted on spindle 22. Spool supports 24 include quick-adjust pins 26 that contact the inside of the prepreg spool core to center the spool 80 on the spindle 22. The spool holding assembly 16 enables rapid prepreg spool change-out and positioning. Spindle 22 is supported at each end by trusses 28 on the upper frame 12.

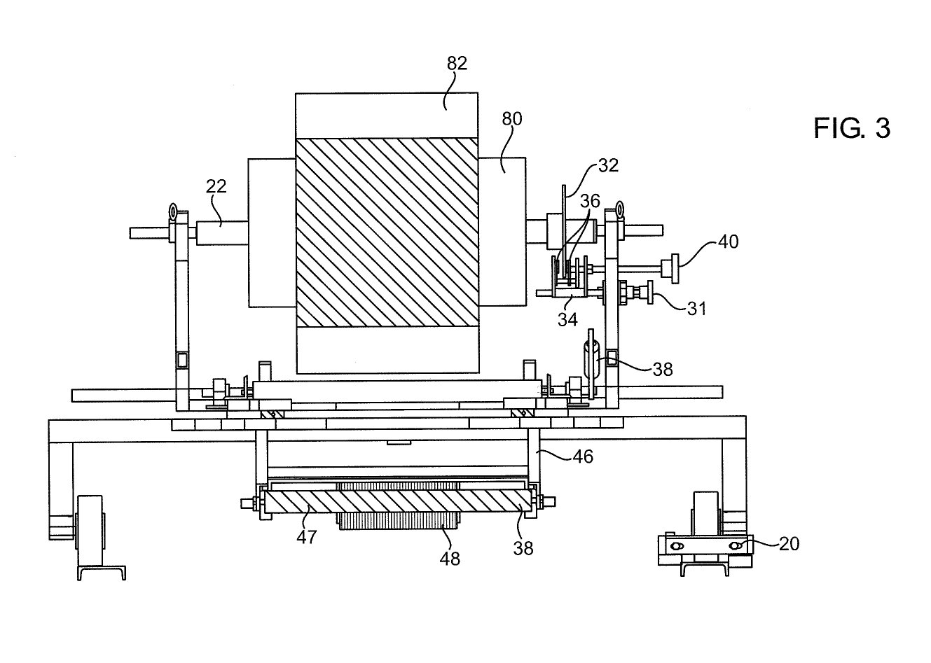

Referring to FIG. 3, the carriage 10 includes a spool positioning system 30 that includes disk 32 and lateral adjustment bracket 34. The spool positioning system 30 controls the lateral position of the spool of prepreg material on the carriage throughout the prepreg dispensing operation. Disk 32 is fixed to spindle 22. The disk 32 is positioned between the arms of a U-shaped bracket 34. A pad 36 coupled to each arm of the bracket 36 contacts the disk 32. Using positioning handle 31, small lateral (i.e., perpendicular to the direction of tape application) adjustments in the alignment of the prepreg tape can be made by laterally moving the bracket 34 during tape dispensing as necessary.

The carriage 10 includes a tensioning system 38 for maintaining a suitable level of tension on the prepreg material during dispensing operation. A friction adjuster 40 applies pressure to the disk 32 and pads 36 within the bracket 34 to establish a baseline resistance to rotation of the prepreg roll during the dispensing operation. This adjuster 40 can be either manually operated or automatically operated based on feedback from tension monitoring sensors (not shown).

The tensioning system 38 includes a spring-loaded arm 42 that provides a measurement of the tension on the prepreg tape. The force of the spring 44 on the spring-loaded arm 42 also compensates for minor fluctuations in force that result from the propulsion of the prepreg dispensing carriage 10 and from the diametric change of the prepreg material as it is dispensed from the spool. In one embodiment (not shown), the tensioning system may further include sensors for tension monitoring and adjustment. Tension roller 47 attached to lateral bar 46 positions the prepreg tape near the surface of the molding tool in preparation for the compaction step.

The compaction assembly 18 acts to press down the prepreg material as it is dispensed onto the surface of the molding tool. The compaction assembly applies compaction pressure regardless of the twist and curvature of the molding tool surface. A compaction roller 48 is made up of a plurality of thin, heavy contiguous disks 50 on a lateral axle 52 with the flat faces of the disks pressed together. The disks 50 have a central bore diameter that is larger than the diameter of the axle 52. The disks 50 have polished faces and/or friction reducing media on the faces of the disks to enable independent movement of each disk. The heavy disks 50 are able to move vertically, so that the edge of each disk contacts the prepreg material to provide compaction. Adjacent the last disk at each end are retention members 54 on the axle 52 to maintain the lateral position of the disks 50 and limit their motion to rotation about the axle and translation perpendicular to the axle 52. Swing away arm 56 of the compaction assembly 18 is pivotably mounted on the upper frame 12 at pivot point 58. The rotational movement of the compaction assembly 18 enables the operator to lift the compaction assembly off of the prepreg tape when the compaction assembly is not in use. The compaction assembly 18 may optionally include other features, including flexible-urethane or pneumatic shaped rollers, and spring or pneumatic loaded “fingers”/arms (not shown).

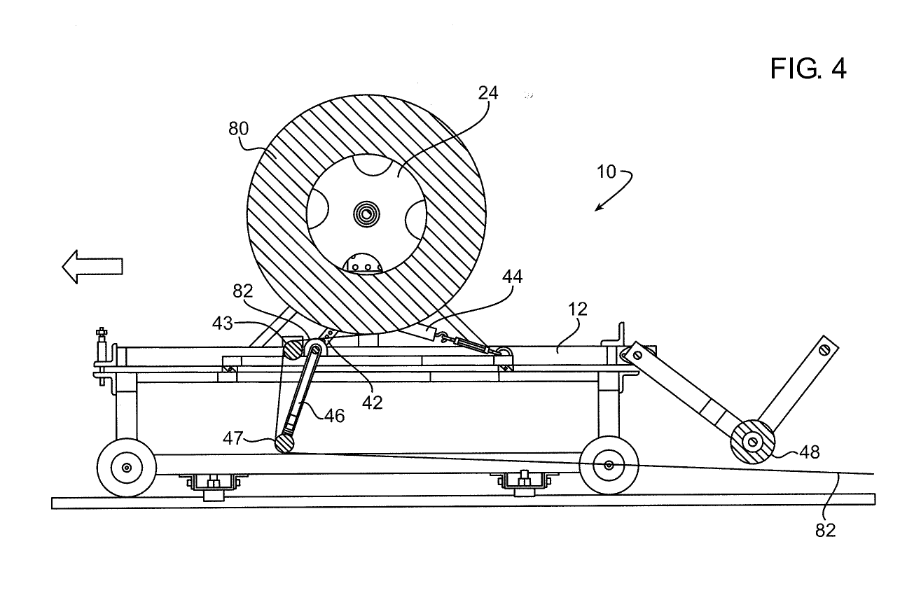

Referring to FIG. 4, as the prepreg material 82 is unwound from the spool 80, it passes over redirect roller 43 and is then positioned near the surface of the molding tool by tension roller 47. The carriage 10 travels across the surface of the molding tool in the direction indicated by the arrow. The compaction assembly 18 is lowered so that compaction roller 48 contacts the prepreg tape 82 and applies compaction pressure to compress the prepreg tape 82 to the surface of the molding tool 60.

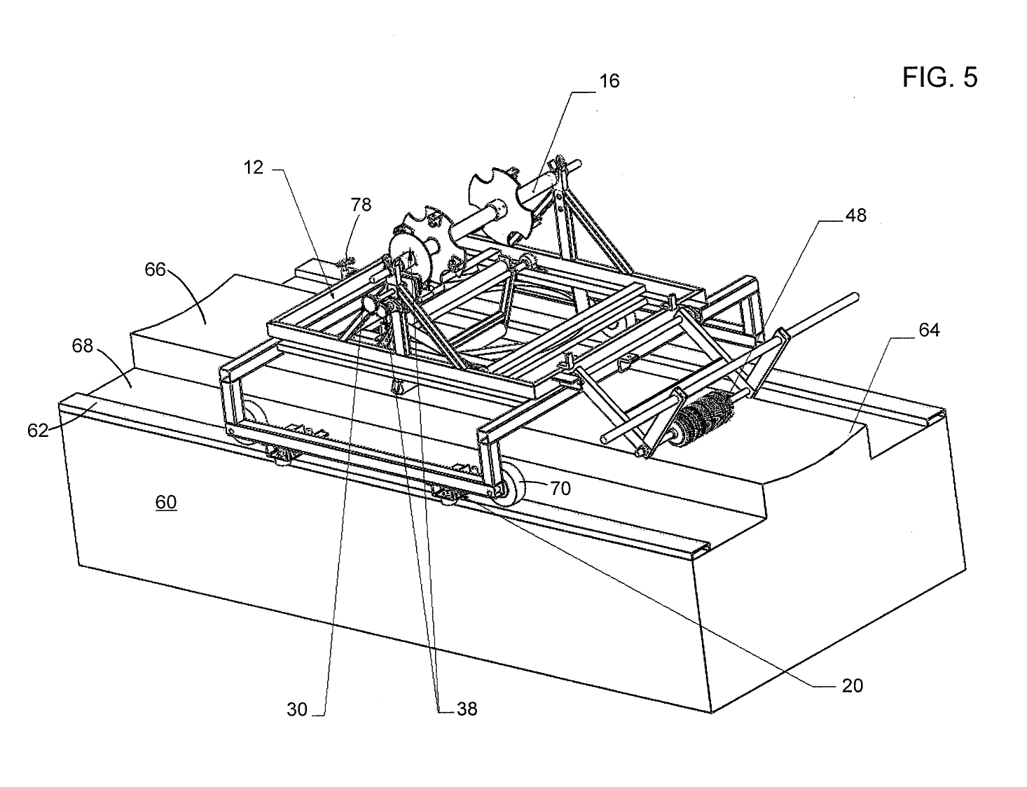

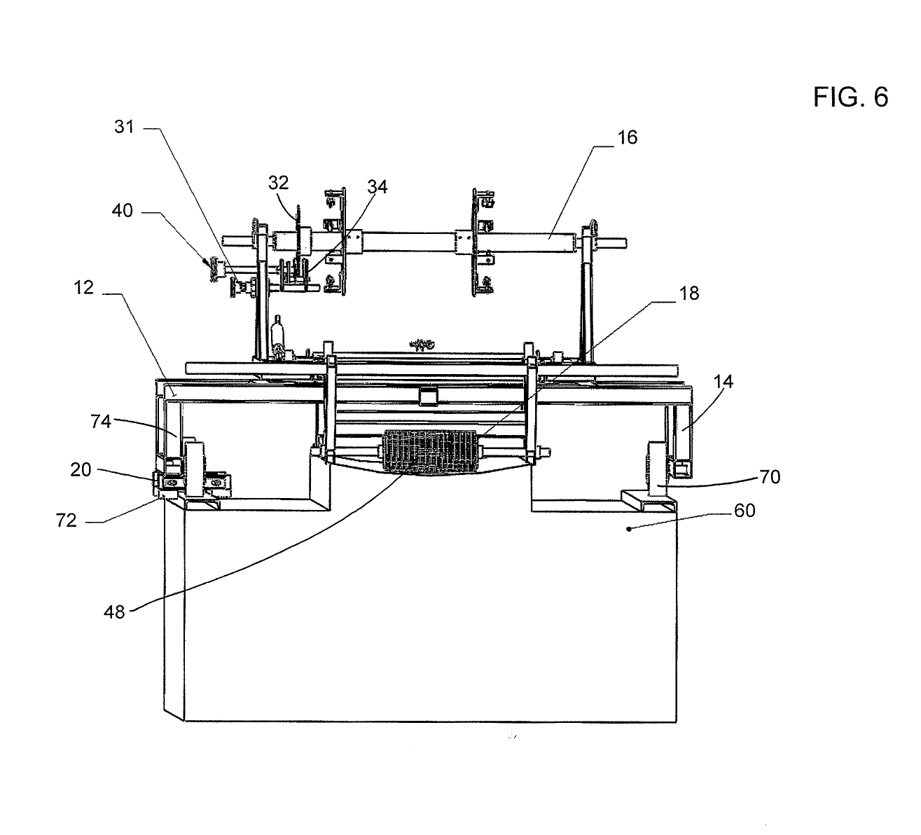

Referring to FIGS. 5 and 6, the carriage 10 may be moved over the surface 64 of a molding tool 60 by wheels 70 positioned on each of the four corners of the base frame 14. The carriage 10 may be self-propelled using, for example, an electric motor (not shown). In one embodiment, the carriage 10 is guided by a rail 62 positioned along the surface of the molding tool 60.

In the illustrated embodiment, the components of the tracking system 20 of the carriage 10 are integrated into the carriage 10 and are coordinated with the configuration of the molding tool 60 to assure the proper placement of the prepreg tape. Typically, the coordination focuses on a specific feature of the final composite structure. As an example, the point where the centerline of a wind blade spar cap contacts the surface of the molding tool 60 may be used as a “key characteristic”. Tracking system 20 maintains precise position of the prepreg dispensing carriage relative to the key characteristic. Components of the tracking system 20 may be embedded in the molding tool surface 64 or in a separate guide rail 62 positioned on the edges of planar portions 68 of the molding tool at either side of a central concave portion 66 of the molding tool 60 as shown in FIGS. 5-7.

The tracking system 20 includes at least one pair of guide rollers 72 mounted to the end of at least one of the legs 74 of the base frame 14 of the carriage and proximate to wheel 70. The pair of guide rollers 72 are space apart so that they engage both sides of rail 62 and traverse along the axis of the rail 62. A second pair of guide rollers 72 may be mounted to a second leg 74 on the same side of the base frame proximate to the second wheel 70. The guide rollers 72 are coordinated with the molding tool to provide definitive position of the carriage 10; provide proper twist of the carriage 10 to mirror that of the molding tool 60; and maintain contact of the carriage 10 to the molding tool 60 along the entire length of the molding tool. Tracking guide rollers 72 also help to eliminate pull-off of the carriage resulting from forces needed to propel the carriage along the molding tool.

In one alternative embodiment, the one or more rails are positioned under the molding tool, rather than on the surface of the molding tool. In another alternative embodiment, a separate rail is not used to guide the carriage. Instead, the molding tool surface itself incorporates key features that are tracked by the carriage so as to assure the proper placement of the prepreg material.

The compaction roller 48 exerts a compressive force to the prepreg tape by contacting the top surface of the structural composite being laminated as the tape is deposited on the molding tool. The compaction roller 48, made up of a plurality of thin heavy, contiguous disks 50, is able to conform to the contours of the surface of the molding tool 64, and in particular, is conformable to the concave portion 66 of the molding tool so as to reduce the tendency of the tape to wrinkle when applied to the concave (or convex) portions of the molding tool surface. With the compaction roller 48, the prepreg tape can be applied to molding tool surfaces having areas of varying degrees of concave curvature, areas having varying degrees of convex curvature and areas that are flat. The prepreg tape any also be applied along a non-linear path on the molding tool surface.

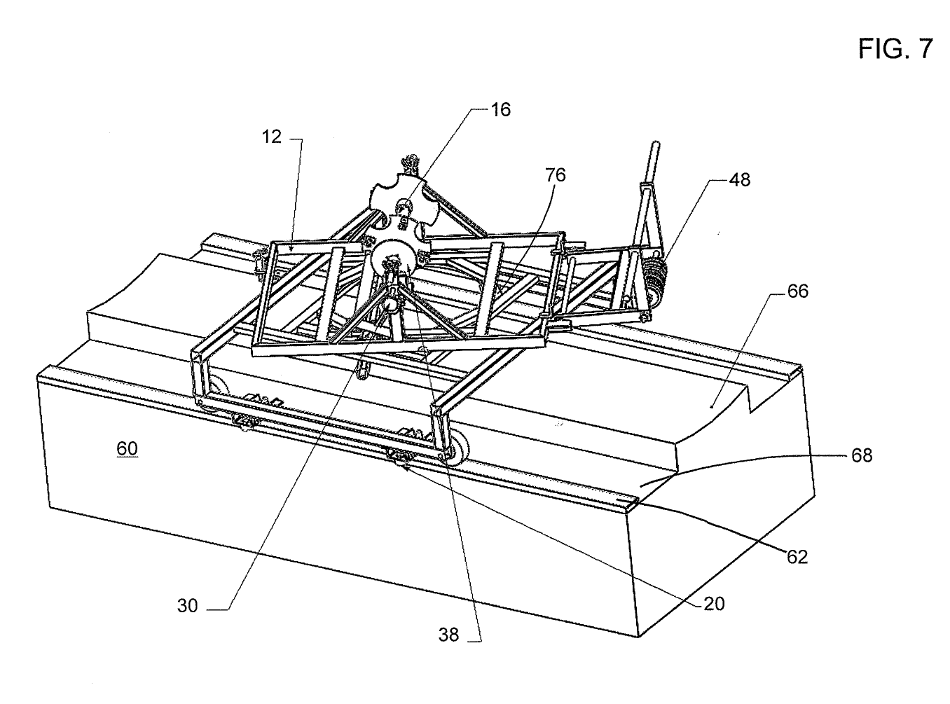

Referring to FIG. 7, the upper frame 12 is rotatably secured to base frame 14 by turntable 76, which enables rotating the prepreg material by 180 degrees without removing the dispensing carriage 10 from the molding tool 60. The turntable 76 allows the prepreg material to pass through the center of the apparatus 10 during the dispensing operation. The locking member 78, when engaged, prevents rotational movement of the upper frame 12 relative to the base frame 14, and establishes the proper location of the prepreg spool for each direction of dispensing on the molding tool 60.

The apparatus of the present invention may further include means for guiding the prepreg lay down to assure controlled fiber alignment. The operation of the carriage assembly 10 may be controlled by a controller (not shown). For example, the carriage may be connected to a controller that is configured to control the placement of the prepreg tape, the tension on the tape, the direction in which the prepreg tape is applied to the surface of the molding tool and the speed at which the prepreg tape is laid down.

The carriage assembly 10 may apply the prepreg material tape starting from either end of the molding tool 60 and may start and stop according to predetermined ply locations. A cutter may be used to automatically cut the ply. In one embodiment, the carriage assembly 10 may include a laser guide (not shown) for determining the ply locations.

In one embodiment, the carriage assembly may be removably coupled to a spool loading station.

In another aspect of the invention, there is provided an apparatus that includes a slitter and accumulator, the apparatus capable of laying down strips of prepreg material formed from a wide prepreg tape product for a structure having in-plane curvature, while significantly reducing the effects of wrinkling on the inner radius. The initial width of the prepreg tape product may be in the range of about 12 inches (30.5 cm) to about 60 inches (152.4 cm).

When building up a composite structure from prepreg tapes, the tapes are usually laid down in straight line directions. Because the tape is being unrolled from a single spool, the fibers cannot stretch in the lay-down process and cannot slide relative to one another. As a result, these prepreg tapes cannot be laid down in an in-plane curvature geometry without creating wrinkling or puckering on the inner radius.

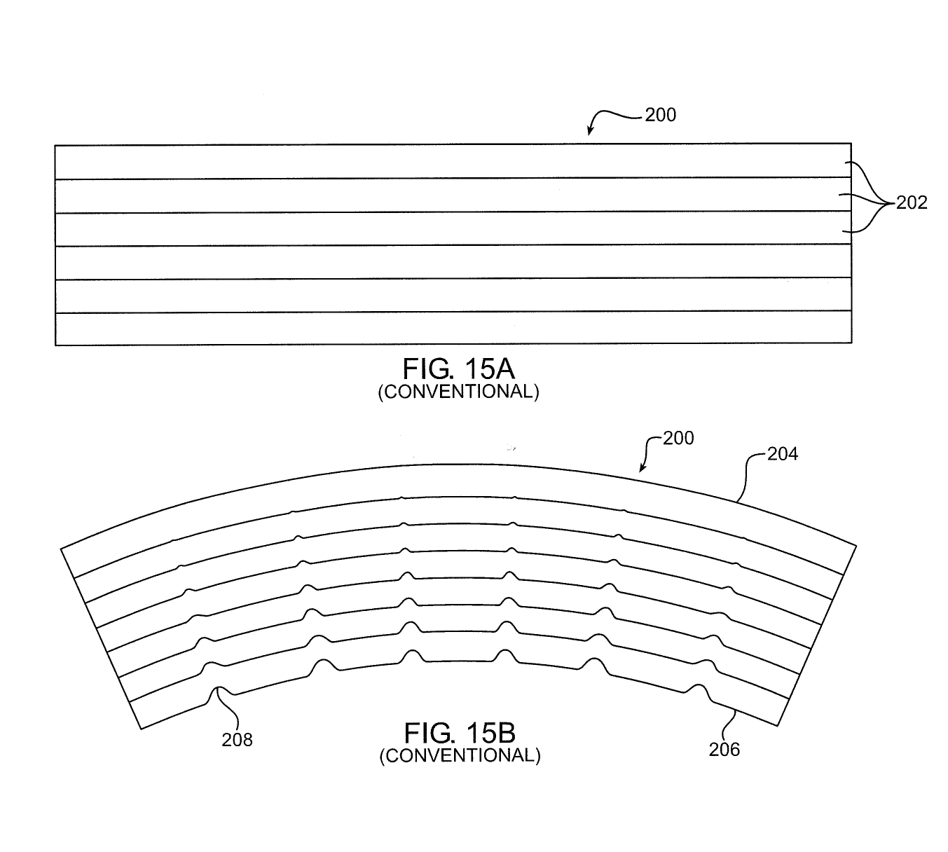

Referring to FIG. 15A, a prepreg tape 200 dispensed using conventional apparatus in a linear direction has a plurality of aligned reinforcing fibers 202 that are pre-impregnated with a polymer. When the tape 200 is applied to a flat, linear surface, the tape lies smoothly without wrinkling or puckering. FIG. 15B illustrates a prepreg tape 200 dispensed in a non-linear, curved direction using conventional apparatus. The tape 200 lies smoothly along the outer edge 204 of the curved surface. However, along the inner edge 206, wrinkles 208 are formed.

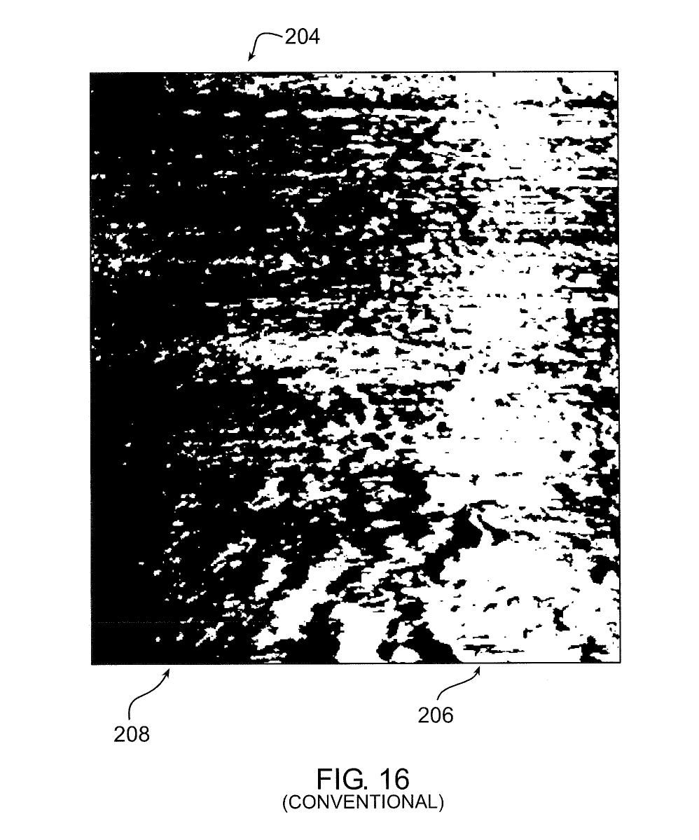

FIG. 16 is a photograph of a 7 inch (17.8 cm) wide strip of prepreg laid down to an in-plane radius of curvature of 130 feet (39.6 m) using a conventional apparatus. The wrinkling and puckering 208 on the inner radius 206 can be clearly seen. This wrinkling creates a loss of orientation of fiber direction and results in loss of composite mechanical properties in this region. Carbon fiber composites are particularly sensitive to loss of compression strength due to such loss of fiber orientation.

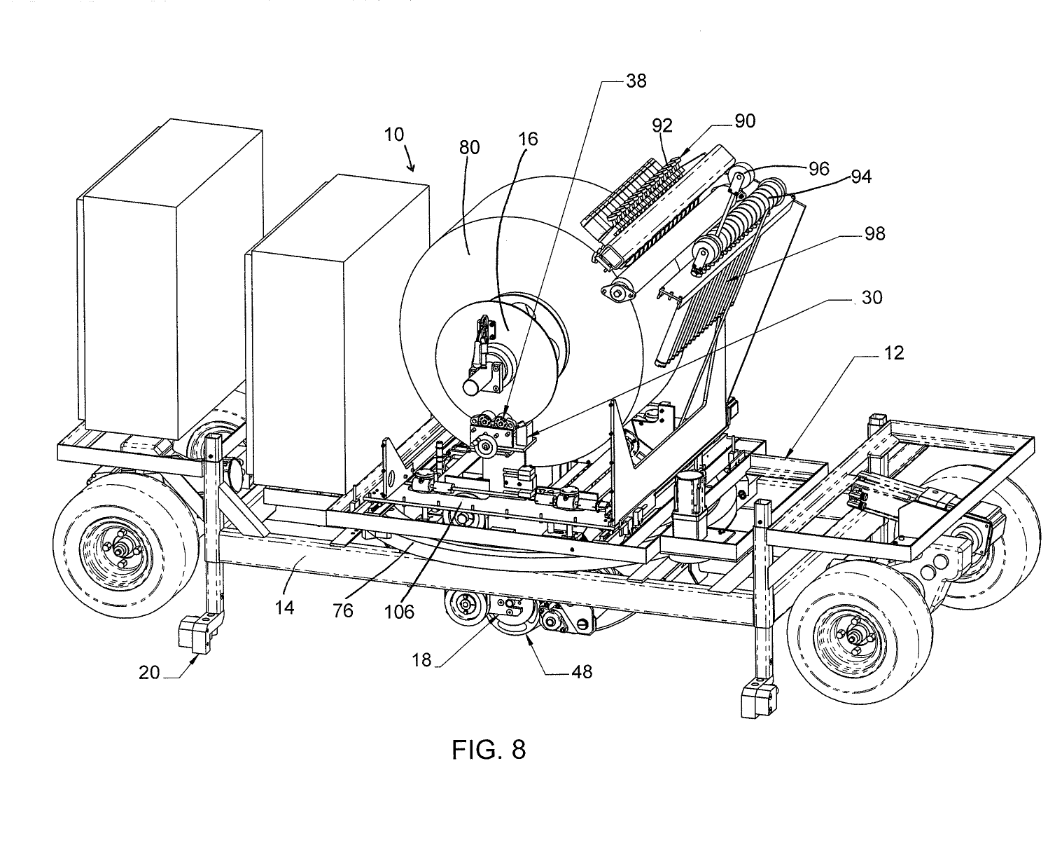

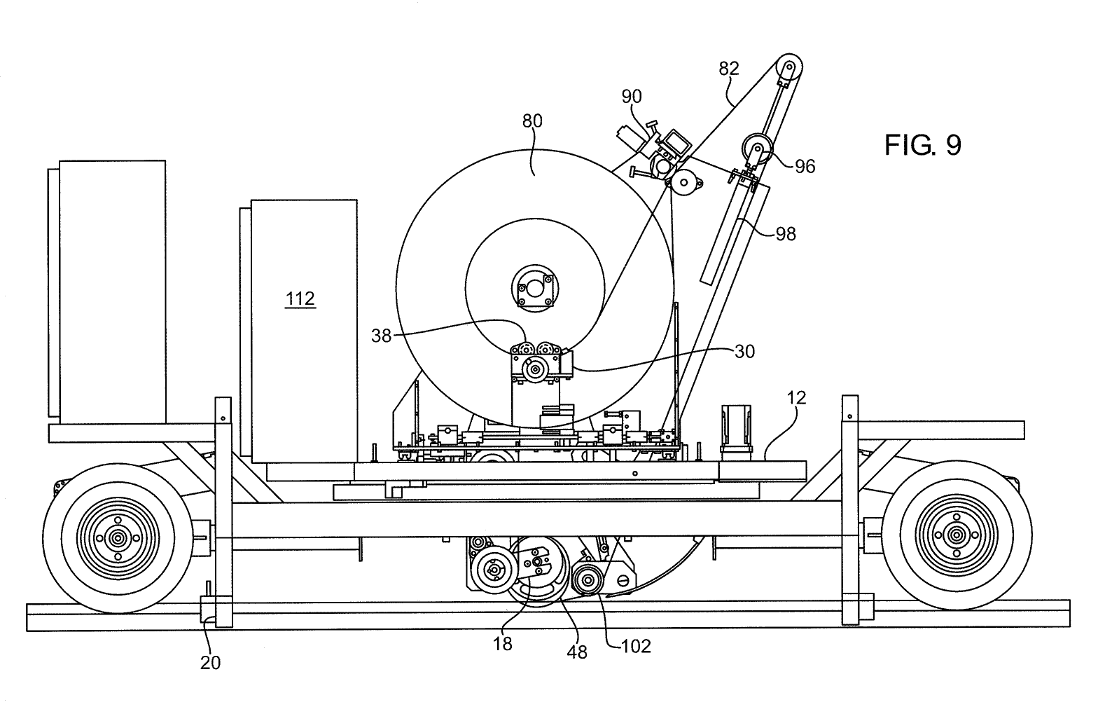

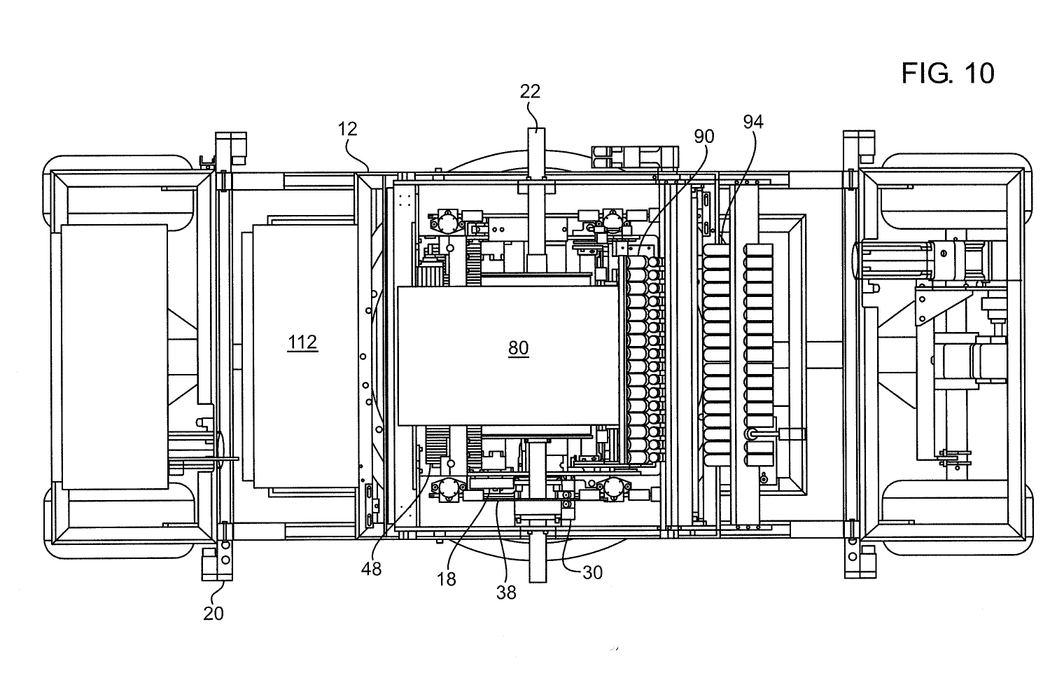

Referring to FIGS. 8-10, another exemplary embodiment of the prepreg tape dispensing apparatus of the present invention is illustrated. The apparatus comprises a movable carriage 10 that includes a spool holding assembly 16 for demountably holding a spool 80 of a continuous web of prepreg tape material 82 having a wide width. As previously described, this embodiment of the carriage 10 includes an upper frame 12 rotatably mounted to a base frame 14. Mounted on the upper frame 12 are a prepreg spool holding assembly 16 and a compaction assembly 18. The base frame 14 includes a tracking system 20 to precisely place the prepreg material on the surface of the molding tool. The carriage assembly 10 includes turntable 76 which enables upper frame 12 to rotate relative to base frame 14, such that application of the prepreg tape material on the molding tool 60 may be carried out in the forward direction and in the reverse direction.

As the prepreg material tape 82 is unwound from the spool 80, it is advanced to a slitter 90 where it is slit into a plurality of strips 84 of prepreg material. The slitter 90 may include, for example, a plurality of stationary knives 92 or rotary knives. The number of strips and the width of the individual strips 84 depend on the degree of non-linearity of the surface of the molding tool 60 to which the strips 84 are applied. For example, the strips 84 may be uniform in width or may have different widths to accommodate the non-linear path of the molding tool 60. While the description of the apparatus herein refers to a molding tool, it is to be understood that the prepreg material may be applied to the surface of a mold, mandrel, or any other surface used to form the composite structure in the prepreg dispensing operation.

In another embodiment, the strips 84 are slit during manufacture of the wide prepreg web prior to being wound on a single spool. The spool 80 of pre-slit strips is then mounted on the spool holding assembly 16.

The carriage 10 includes a mechanism for taking up the difference in length of the individual strips 84 resulting from the non-linear path of the molding tool 60. In one embodiment, an accumulator 94 is used. Accumulator 94 includes a plurality of rollers 96, each strip of prepreg 84 having an associated roller that is independently extendable and retractable as needed to manage the excess length of the individual strip resulting from the non-linear path on the molding tool 60. The accumulator rollers 96 maintain tension in the individual strips 84 so that the individual strips 84 are smoothly applied to the molding tool 60. Extension and retraction of the rollers 96 of the accumulator 94 may be effected by a plurality of actuators 98 coupled to the rollers 96. In one embodiment, the actuators 98 include air cylinders.

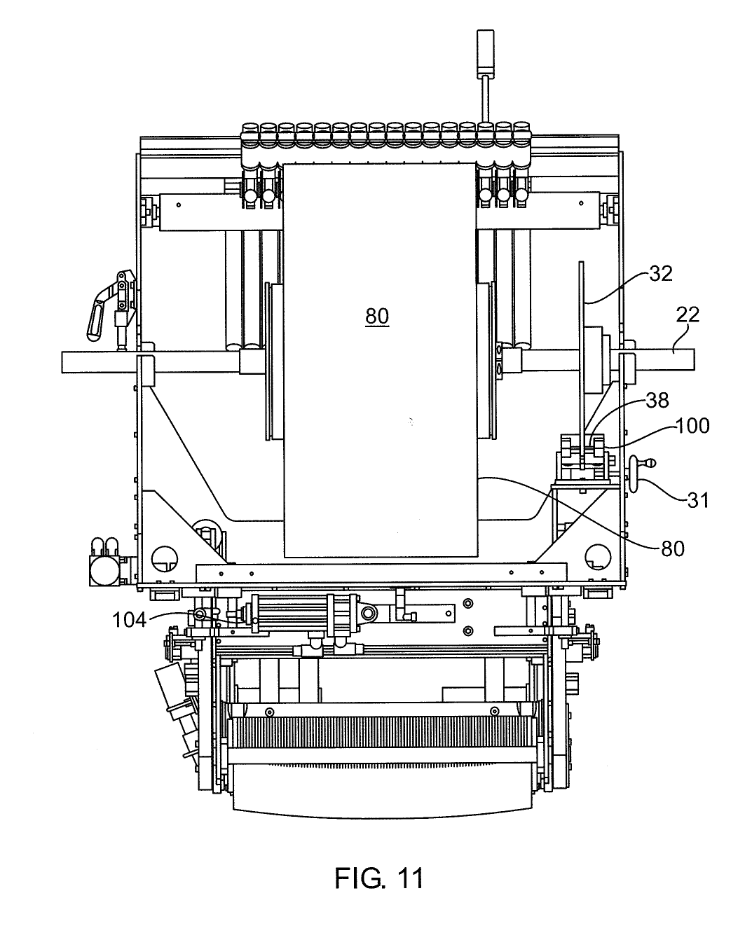

Referring to FIG. 11, the carriage 10 includes a tensioning system 38 that includes a brake disk 32 fixed to spindle 22, and pneumatically actuated brake pads 100 that apply friction to the disk 32 under programmed control.

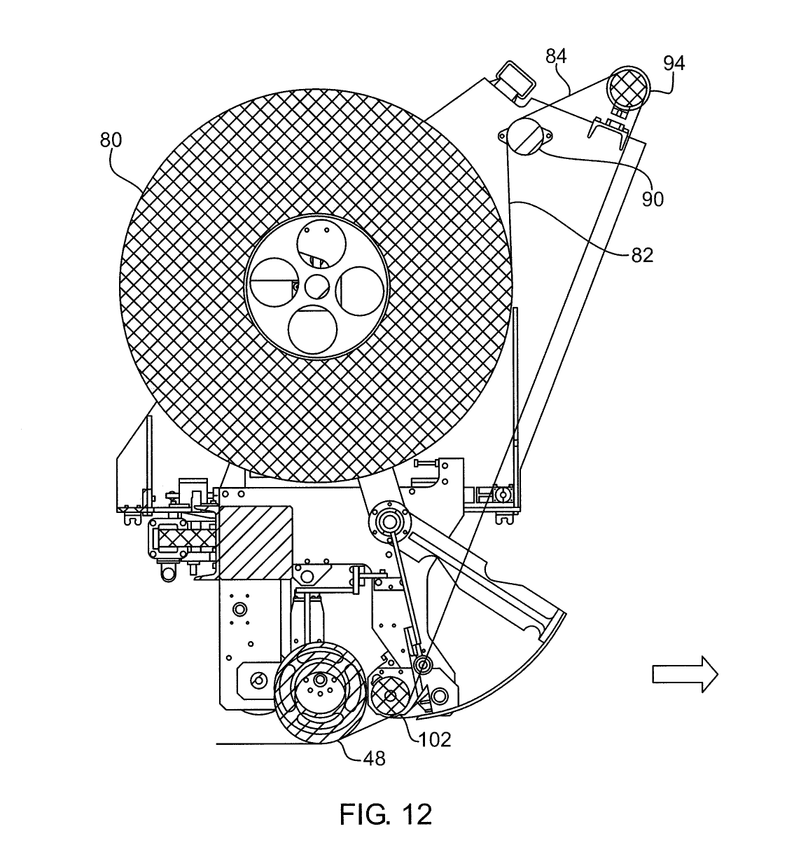

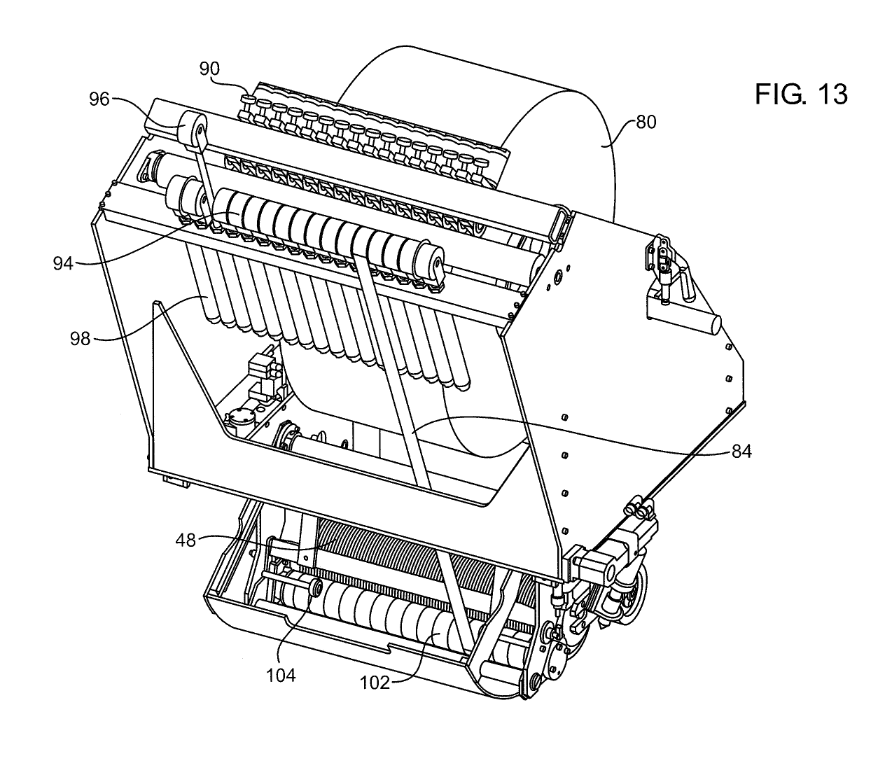

Referring to FIGS. 12 and 13, as the prepreg material 82 is unwound from the spool 80, it is advanced to a slitter 90 where it is slit into a plurality of strips 84 of prepreg material. The prepreg strips 84 travel over the rollers 96 of the accumulator 94, the path each strip independently controlled to manage any excess length of the individual strip resulting from the non-linear path on the molding tool 60 to which the strip is applied. From the accumulator rollers 96, the strips proceed to guide rollers 102 which position the strips near the surface of the molding tool. The compaction roller 48 contacts the prepreg strips 84 and applies compaction pressure to compress the prepreg strips 84 to the surface of the molding tool 60. The surface of the molding surface 60 may include concave and/or convex areas having varying degrees of curvature, and/or flat areas. Although the path of the individual prepreg strips 84 on the surface of the molding tool may be nonlinear or curved, the apparatus 10 is able to lay down the strips with little or no wrinkling of the prepreg layers and/or gaps between the strips on the mold.

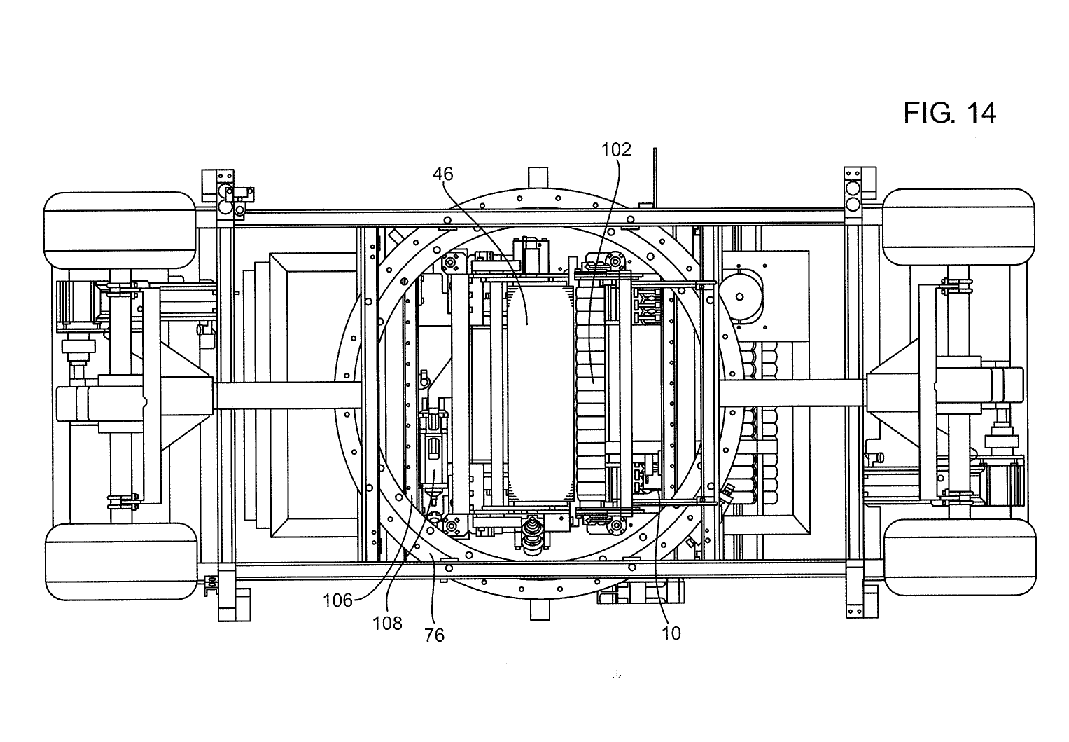

FIGS. 12-14 illustrate the steps involved in the positioning the tape on the molding tool. Before being slit into strips 84, the tape 82 is guided by the threading guide 104 along the tape path as shown in FIG. 12, with the slitter 90 inactivated. The tape 82 is clamped or held to the surface of the mold tool 60. The slitter 90 is then activated and the carriage 10 begins to move forward (in the direction indicated by the arrow), pulling the tape 82 until the slit portion of the tape (i.e., the strips 84) have extended past the compaction roller 48. The tape 84 is then cut laterally and the carriage 10 advances out of the way so the tape just laid down can be pulled up and discarded. The carriage 10 then moves to the programmed start position for the next layer to be applied, and the compaction roller 48 is lowered to begin adhering the prepreg strips 84 to the molding tool surface 64. From this point, the prepreg strips 84 are aligned by the crowned accumulator rollers 96 and the crowned guide roller 102. As the carriage 10 transitions from straight portions of the molding surface 64 to swept portions, or from one radius of sweep to another, the cross carriage 106 is shifted laterally by the cross carriage drive motor 104 to keep the center of the tape aligned with the center of the molding surface. In this embodiment, the amount of shift is previously input as offset data points into a table in the controller 112. This same cross carriage 106 is used to move the carriage an additional or lesser distance as needed to track the tape 82 coming off the spool 80, as detected by the web edge sensor 110. This is done to provide a degree of compensation for tape not evenly wound on the spool 80, or tape 82 that has shifted on the spool 80 during transport.

The operation of the carriage assembly may be controlled by a controller 112. For example, the carriage 10 may be connected to a controller 112 that is configured to control the placement of the prepreg tape 82 or strips 84, the tension on the tape or strips, the direction in which the prepreg tape or strips are applied to the surface of the molding tool 60 and the speed at which the prepreg tape or strips are laid down.

The carriage assembly 10 may apply the prepreg material tape 82 or strips 84 starting from either end of the molding tool 60 and may start and stop according to predetermined tape or strip locations. A cutter, such as an ultrasonic knife (not shown) may be used to automatically cut the tape or strips. In one embodiment, the carriage assembly may include a laser guide for determining the tape or strip ply locations.

The prepreg tape material 82 on the spool 80 may have a liner or backing layer adhered to the prepreg tape 82. In one embodiment, the liner or backing layer of the prepreg material is removed from the underside of prepreg web prior to laying down the tape 82 or individual strips 84 of prepreg material, and is taken up on liner take-up roll. In one embodiment (not shown), the prepreg material web 82 includes a liner on the upper surface of the web that is removed prior to laying down the web. The carriage assembly may further include means for detecting incomplete removal of the liner or backing from the prepreg material web.

In one embodiment, the carriage assembly 10 may be removably coupled to a spool loading station.

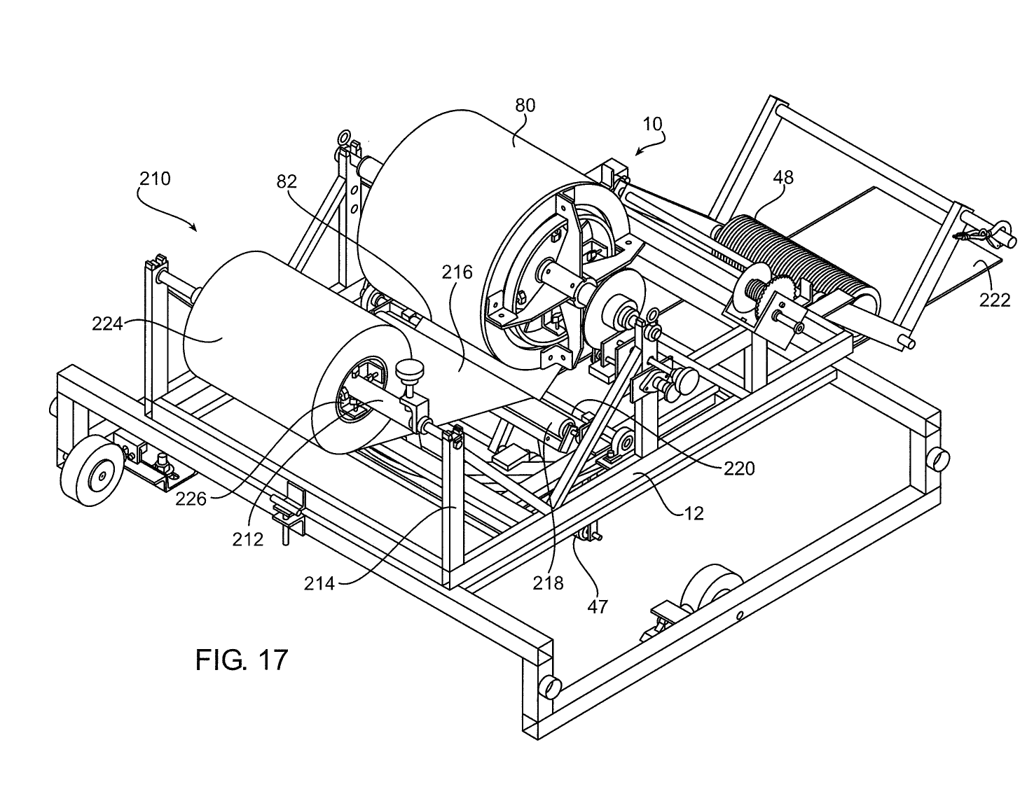

Referring to FIG. 17, another exemplary embodiment of the prepreg tape dispensing apparatus of the present invention is illustrated. The apparatus includes a scrim dispensing assembly 210 that include a spindle 212 supported at each end by mounting bracket 214 on upper frame 12. Spool supports 226 mounted on spindle 212 contact the inside of the spool of scrim material 224.

A layer of scrim material 216 may be unwound from spool 224 and joined to prepreg material 82 as it is being unwound from prepreg spool 80 by passing the layer of scrim material 216 and the prepreg material 82 through nip rollers 218, 220 just prior to lay down of the prepreg material. The prepreg material 82 with the scrim material applied thereto forms a scrim reinforced prepreg 222 that is then positioned near the surface of the molding tool 60 by tension roller 47. As the carriage 10 travels across the molding tool 60, the compaction roller 48 contacts the scrim reinforced prepreg 222 and applies pressure to compress the prepreg tape to the surface of the molding tool 60.

The application of the scrim layer to the prepreg material just prior to lay down of the prepreg material provides a path for air evacuation between a first prepreg layer and a second prepreg layer subsequently laid down over the first layer of prepreg. Mounting the spool of scrim material directly on the cart provides greater flexibility as it is not always necessary and/or desirable to use a prepreg material having a scrim layer. In some instances, it is desirable to lay down a prepreg layer with no scrim and in other instances, a scrim reinforced prepreg layer is desirable.

The scrim material includes yarns arranged in a grid or an open mesh and may be made of any suitable material. Examples of yarn materials include thermoplastic yarns, glass yarns, cellulose-based yarns and aramid yarns. Suitable materials for the scrim include polyester such as polyethylene terephthalate and polybutylene terephthalate and copolymers thereof, polyamide such as nylon 6, nylon 66, nylon 10, nylon 11 and nylon 12, polyethersulphone, polypropylene, viscose staple yarn, meta and para-aramid, fiberglass, jute, flax, cotton and combinations of two or more thereof. Polyester scrim materials are commercially available, for example, from Dextex Inc. of Georgia (U.S.A.), a subsidiary of James Dewhurst.

The strands of the scrim may be in the range of about 40 to about 300 denier, or about 50 to about 150 denier, or about 50 to about 100 denier. The spacing of the warp and weft threads may be in the range of about 1 per inch to 10 per inch (1 to 10 per 2.54 cm), or about 2 per inch to about 4 per inch (2 to 4 per 2.54 cm). In one embodiment, the spacing of the warp threads is 2 per inch (2 per 2.54 cm) and the spacing of the weft threads is 1 per inch (1 per 2.54 cm).

The scrim material, in one embodiment, is constructed of polyester threads having straight warp threads and weft threads that are “wavy” or sinusoidal.

In another embodiment, the scrim material is constructed of polyester fibers having a round cross-section arranged in a grid of fibers at 0° approximately ⅜ inch (9.53 mm) apart and fibers at +/−45° spaced 15/16 inch (23.82 mm) apart. Such scrim material is commercially available from Bellingroth GmbH & Co. (Germany) under the trade name Bafatex.

### EXAMPLE

A four wheeled cart was constructed to hold a spool of prepreg material having an outside diameter of up to 32 inches (81.3 cm) and an inside diameter of 12 inches (30.5 cm), and having a length of approximately 1800 feet (549 m). A 600 millimeter wide web of prepreg was slit into twelve strips of 2 in. (50.8 mm) in width with stationary knives mounted on the cart.

Approximately three spools of prepreg material were used to construct a wind turbine spar cap. The spools were loaded onto the cart by an overhead crane or forklift.

The problem of wrinkling was reduced by laying down narrower prepreg strips from a given radius of curvature. An analysis of this was done for the 130 feet (40 meter) radius of curvature and is shown in Table 1 below. As can be seen for this particular analysis, when strips are approximately 2.0 inches (5.0 cm) wide, the wrinkling area is reduced to approximately 8% of the baseline for 24 inch (61 cm) wide prepreg strip.

TABLE 1
Wrinkle area for a 600 mm wide strip on a 40 meter radius

| number of strips | av. Width mm | av width in. | wrinkle area | % |
|---|---|---|---|---|
| 1 | 600.00 | 23.62 | 4.181 | 100.0 |
| | | | | Baseline |
| 2 | 300.00 | 11.81 | 2.090 | 50.0 |
| 3 | 200.00 | 7.87 | 1.394 | 33.3 |
| 4 | 150.00 | 5.91 | 1.045 | 25.0 |
| 5 | 120.00 | 4.72 | 0.836 | 20.0 |
| 6 | 100.00 | 3.94 | 0.697 | 16.7 |
| 7 | 85.71 | 3.37 | 0.597 | 14.3 |
| 8 | 75.00 | 2.95 | 0.523 | 12.5 |
| 9 | 66.67 | 2.62 | 0.465 | 11.1 |
| 10 | 60.00 | 2.36 | 0.418 | 10.0 |
| 11 | 54.55 | 2.15 | 0.380 | 9.1 |
| 12 | 50.00 | 1.97 | 0.348 | 8.3 |
| | | | | Target |
| 13 | 46.15 | 1.82 | 0.322 | 7.7 |
| 14 | 42.86 | 1.69 | 0.299 | 7.1 |
| 15 | 40.00 | 1.57 | 0.279 | 6.7 |
| 16 | 37.50 | 1.48 | 0.261 | 6.3 |
| 17 | 35.29 | 1.39 | 0.246 | 5.9 |
| 18 | 33.33 | 1.31 | 0.232 | 5.6 |
| 19 | 31.58 | 1.24 | 0.220 | 5.3 |
| 20 | 30.00 | 1.18 | 0.209 | 5.0 |
| 21 | 28.57 | 1.12 | 0.199 | 4.8 |
| 22 | 27.27 | 1.07 | 0.190 | 4.5 |
| 23 | 26.09 | 1.03 | 0.182 | 4.3 |
| 24 | 25.00 | 0.98 | 0.174 | 4.2 |
| 25 | 24.00 | 0.94 | 0.167 | 4.0 |
| 26 | 23.08 | 0.91 | 0.161 | 3.8 |
| 27 | 22.22 | 0.87 | 0.155 | 3.7 |
| 28 | 21.43 | 0.84 | 0.149 | 3.6 |
| 29 | 20.69 | 0.81 | 0.144 | 3.4 |
| 30 | 20.00 | 0.79 | 0.139 | 3.3 |
| 31 | 19.35 | 0.76 | 0.135 | 3.2 |
| 32 | 18.75 | 0.74 | 0.131 | 3.1 |
| 33 | 18.18 | 0.72 | 0.127 | 3.0 |
| 34 | 17.65 | 0.69 | 0.123 | 2.9 |
| 35 | 17.14 | 0.67 | 0.119 | 2.9 |
| 36 | 16.67 | 0.66 | 0.116 | 2.8 |
| 37 | 16.22 | 0.64 | 0.113 | 2.7 |
| 38 | 15.79 | 0.62 | 0.110 | 2.6 |
| 39 | 15.38 | 0.61 | 0.107 | 2.6 |
| 40 | 15.00 | 0.59 | 0.105 | 2.5 |
| 41 | 14.63 | 0.58 | 0.102 | 2.4 |

While this exemplary lay-up could be achieved by using a prepreg product that consisted of 2-inch (5.1 cm) wide strips, production and packaging of individual prepreg strips would add significant cost over starting with a 24 inch (61.0 cm) wide prepreg product on a single spool.

The apparatus and process of the present invention is particularly useful for the construction of wind turbine components. However, the apparatus and process can also be used for, for example, in the construction of structural and aerodynamic components for airplanes, helicopters, automobile bodies, rail cars, marine crafts and the like.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A carriage to apply a resin impregnated web to the contoured surface of molding tool for a wind blade spar cap, the carriage comprising:
an upper frame mounted to a base frame, the upper frame having mounted thereon:
a spool holding assembly for holding a spool of resin impregnated web wound thereon,
a web compaction assembly comprising a compaction roller configured to conform to concave and convex portions of the surface of the molding tool for compacting the resin impregnated web onto the surface of the molding tool, and
a web tensioning system for exerting tension on the resin impregnated web;
the base frame comprising:
a plurality of wheels mounted on the base frame and supporting the carriage, the wheels engaging the surface of the molding tool for propelling the carriage along the contoured surface of the wind blade spar cap molding tool; and
a tracking system for tracking the surface of the molding tool, the carriage reciprocally movable with respect to the contours of the surface of the molding tool.

2. The carriage according to claim 1 wherein the spool holding assembly comprises an alignment system for laterally aligning the spool of prepreg web relative to the surface of the molding tool.

3. The carriage according to claim 1 wherein the compaction roller comprises a plurality of contiguous disks supported on an axle, the disks having a central bore diameter that is greater than the outer diameter of the axle.

4. The carriage according to claim 1 wherein the upper frame is rotatably mounted on the base frame.

5. The carriage of claim 4 wherein the upper frame rotates at least 180° on the base frame to permit changing the direction of application of the resin impregnated web on the surface of the molding tool.

6. The carriage of claim 1 further comprising a turntable coupled to the upper frame and the base frame to permit rotation of the upper frame on the base frame.

7. The carriage of claim 1 wherein the web tensioning system comprises an actuated disk brake.

8. The carriage of claim 1 wherein the molding tool comprises at least one rail and the tracking system comprises at least two guide rollers that engage the at least one rail.

9. The carriage of claim 1 wherein the width of the resin impregnated web is within the range of about 11.5 inches (292 mm) to about 60 inches (152.4 cm).

10. The carriage of claim 1 further comprising a slitter for slitting the resin impregnated web lengthwise into a plurality of strips, the slitter mounted on and rotatable with the upper frame.

11. The carriage of claim 10 wherein the slitter comprises a plurality of knives.

12. The carriage of claim 10 wherein the width of the plurality of strips of resin impregnated web is uniform.

13. The carriage of claim 10 wherein the width of the plurality of strips of resin impregnated web is non-uniform.

14. The carriage of claim 10 further comprising a plurality of accumulator rollers disposed downstream of the slitter, each accumulator roller being independently activatable for accumulating and de-accumulating a portion of a respective strip of resin impregnated web, the accumulator rollers mounted on and rotatable with the upper frame.

15. The carriage of claim 1 further comprising a controller configured to control at least one of:
the placement of the resin impregnated web on the surface of the molding tool;
the tension exerted by the tensioning system on the web;
the direction in which the web is applied to the surface of the molding tool; and
the speed at which the web is applied to the surface of the molding tool.

16. A carriage to apply a resin impregnated web to the contoured surface of molding tool, the carriage comprising:
an upper frame mounted to a base frame, the upper frame having mounted thereon:
a first spool holding assembly for holding a spool of resin impregnated web wound thereon,
a second spool holding assembly for holding a spool of scrim material mounted thereon;
a web compaction assembly comprising a compaction roller configured to conform to concave and convex portions of the surface of the molding tool for compacting the resin impregnated web onto the surface of the molding tool, and
a web tensioning system for exerting tension on the resin impregnated web;
the base frame comprising:
a plurality of wheels mounted on the base frame and supporting the carriage, the wheels engaging the surface of the molding tool for propelling the carriage along the contoured surface of the wind blade spar cap molding tool; and
a tracking system for tracking the surface of the molding tool, the carriage reciprocally movable with respect to the contours of the surface of the molding tool.

17. The carriage according to claim 16 wherein the upper frame is rotatably mounted on the base frame.

18. The carriage of claim 16 wherein the upper frame rotates at least 180° on the base frame to permit changing the direction of application of the resin impregnated web on the surface of the molding tool.

19. The carriage of claim 16 further comprising a turntable coupled to the upper frame and the base frame to permit rotation of the upper frame on the base frame.

20. The carriage of claim 16 further comprising a nip for joining a layer of scrim material from the spool of scrim material to the resin impregnated web prior to compacting the resin impregnated web onto the surface of the molding tool.
